(19) United States
(12) Patent Application Publication
(10) Pub. No.: US 2025/0131186 A1
(43) Pub. Date: Apr. 24, 2025

(54) Workplace Condition and Safety Monitoring

(71) Applicant: Edify.ai, Inc., Salt Lake City, UT (US)

(72) Inventors: Manoj Perumal, Riverton, UT (US); Cory Linton, Holladay, UT (US); Andrew Adams, Salt Lake City, UT (US); Tanner Hatch, Lehi, UT (US)

(21) Appl. No.: 18/922,357

(22) Filed: Oct. 21, 2024

Related U.S. Application Data
(60) Provisional application No. 63/592,071, filed on Oct. 20, 2023.

(51) Int. Cl. G06F 40/174; G06F 40/134; G06V 10/70; G06V 20/52

(52) U.S. Cl. CPC G06F 40/174; G06F 40/134; G06V 10/70; G06V 20/52

(57) ABSTRACT

A safety management application may train a model to identify safety hazards and corrective actions based on a plurality of tagged images. A safety management application may recognize a safety hazard in a received image using the model. A safety management application may identify a corrective action to remediate the safety hazard. A safety management application may provide the corrective action to a user.

### CROSS REFERENCE TO RELATED APPLICATIONS

This application claims priority under 35 U.S.C. § 119 to U.S. Provisional Patent Application No. 63/592,071, filed Oct. 20, 2023 and titled “Workplace Condition and Safety Monitoring,” which is incorporated herein by reference in its entirety.

### BACKGROUND

The present disclosure relates to workplace safety monitoring.

Safety in the workplace today hinges greatly upon the awareness and vigilance of the employees themselves. Occasional training sessions are provided, but the onus largely falls on the workforce to implement and adhere to safe practices during their daily tasks. This responsibility, however, often encounters challenges due to the fragmented nature of safety practices within companies.

Companies do establish specific safety protocols and processes, encompassing incident reporting, observations, audits, permits, and pre-task plans, among others. These protocols are enforced at the frontline level. However, a holistic view of safety, encompassing all aspects of the work environment, is lacking in the industry today.

To bridge this gap and enhance safety consciousness, it is imperative to remind the frontline workforce about the environment in which they operate, the tasks they perform, and the potential hazards that surround them. Such reminders serve to anchor employees in the present moment, cultivating not only their own safety but also the safety of those working alongside them. Fostering a comprehensive safety culture within the workplace requires a harmonious blend of employee awareness, periodic training, and the integration of safety processes. A united approach towards safety will not only protect individuals but also contribute to a safer work environment for all.

### SUMMARY

In some aspects, the techniques described herein relate to a method including: training a model to identify safety hazards and corrective actions based on a plurality of tagged images; recognizing a safety hazard in a received image using the model; identifying a corrective action to remediate the safety hazard; and providing the corrective action to a user.

In some aspects, the techniques described herein relate to a method, further including: escalating the corrective action in response to determining that no corrective action has been taken to remediate the safety hazard.

In some aspects, the techniques described herein relate to a method including: ingesting natural speech; identifying a situation for documentation based on the natural speech; identifying a form for recording the situation; and completing the form using the ingested natural speech and other contextual information.

In some aspects, the techniques described herein relate to a method, wherein the contextual information includes an identity of a speaker, a date, a time, and a location.

In some aspects, the techniques described herein relate to a method, wherein the issue includes a safety observation or a safety meeting.

In some aspects, the techniques described herein relate to a method, further including generating a score for a safety meeting based on natural speech ingested from the safety meeting.

However, this list of features and advantages is not all-inclusive and many additional features and advantages are within the scope of the present disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

FIG. 1 shows a high-level block diagram illustrating one embodiment of a system for capturing and analyzing multimodal inputs, including text, speech, and images, to improve workplace safety adherence.

FIG. 2 shows a block diagram illustrating one embodiment of a computing device including a safety management application.

FIG. 3 is a flowchart depicting an example method for analyzing an image and providing notifications and feedback, according to the techniques introduced herein.

FIG. 4 is a flowchart depicting an example method for completing safety documentation, according to the techniques introduced herein.

FIG. 5 is a flowchart depicting an example method for accessing safety information using a trained chatbot, according to the techniques introduced herein.

FIG. 6 is an example illustration showing a workplace environment.

FIG. 7 depicts an example of a first user interface for a conversational checklist.

FIG. 8 depicts an example of a second user interface for a conversational checklist.

FIG. 9 depicts an example of a third user interface for a conversational checklist.

FIG. 10 depicts an example of a fourth user interface for a conversational checklist.

### DETAILED DESCRIPTION

The technology described in this disclosure relates to workplace condition and safety monitoring and particularly employing multimodal large language models (LLM), generative, and other artificial intelligence (AI) to improve workplace conditions and safety monitoring. As an example, the technology described herein provides for workplace safety monitoring using image recognition and other multimodal LLMs to alert, provide corrective actions, and train the workforce. Additionally, the technology described herein provides for using multimodal LLMs and other AI to assist the workforce in completing required safety forms. Further, the technology described herein provides for an interactive safety manual and documentation powered by an AI assistant. Finally, the technology described herein provides for AI analysis of safety meetings and providing feedback and/or correction as needed to improve workplace safety.

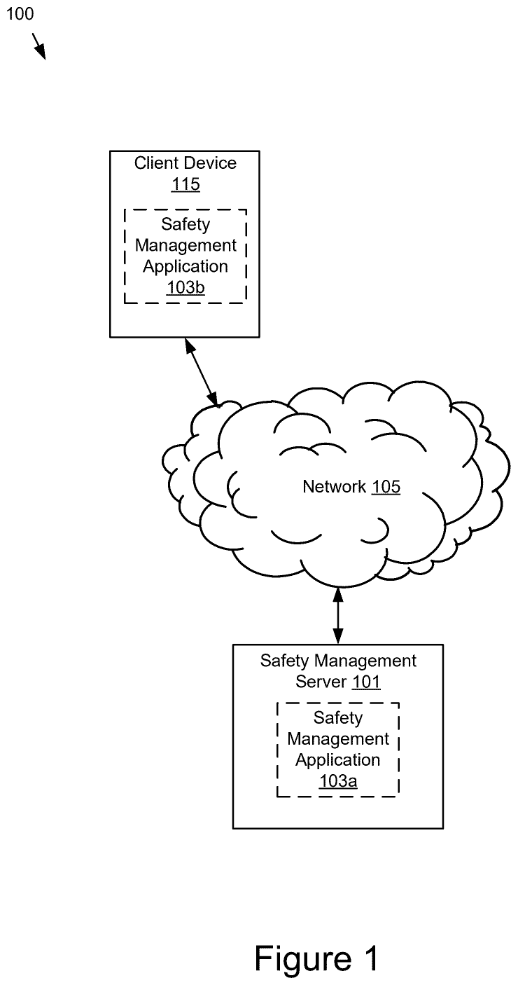

FIG. 1 shows a high-level block diagram illustrating one embodiment of a system 100 for capturing and analyzing multimodal inputs, including, for example, text, audio, video, images, etc., to improve workplace safety adherence. The illustrated system 100 may have one or more client devices 115 that can be accessed by users and a safety management server 101. In the illustrated embodiment, the entities of the system 100 are communicatively coupled via a network 105.

The network 105 can be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some embodiments, the network 105 may be a peer-to-peer network. The network 105 may also be coupled to or include portions of a telecommunications network for sending data in a variety of different communication protocols. In some embodiments, the network 105 may include Bluetooth communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 105 coupled to the client device 115 and the safety management server 101, in practice one or more networks 105 can be connected to these entities.

In some embodiments, the system 100 includes a safety management server 101 coupled to the network 105. In some embodiments, the safety management server 101 may be either a hardware server, a software server, or a combination of software and hardware. The safety management server 101 may be, or may be implemented by, a computing device including a processor, a memory, applications, a database, and network communication capabilities. In the example of FIG. 1, the components of the safety management server 101 are configured to implement a safety management application 103a described in more detail below. In one embodiment, the safety management server 101 provides services to a construction company for analyzing images and identifying safe and unsafe working conditions in images or videos of construction sites. While the examples herein describe recognition of safety related conditions of a construction worksite, it should be understood that the techniques may be used in any work environment. For example, the inputs for analysis and processing may be received from a manufacturing facility, agricultural facility, energy production facility, healthcare facility, etc.

In some embodiments, the safety management server 101 sends and receives data to and from other entities of the system 100 via the network 105. For example, the safety management server 101 sends and receives multimodal data to and from the client device 115. The multimodal data received by the safety management server 101 can include audio, images, videos, text messages and may include data captured by the client device 115 or data retrieved by client device 115 from other sources. Although only one safety management server 101 is shown in FIG. 1, it should be understood that there may be any number of servers or a server cluster.

The client device 115 may be a computing device that includes a memory, a processor and a camera, for example a laptop computer, a desktop computer, a tablet computer, a mobile telephone, a smartphone, a webcam, a user wearable computing device or any other electronic device capable of accessing network 105. The client device 115 may provide general graphics and multimedia processing for any type of application. The client device 115 includes a display for viewing information provided by the safety management server 101. While FIG. 1 illustrates one client device 115, the disclosure applies to a system architecture having one or more client devices 115.

The client device 115 is adapted to send and receive multimodal data to and from the safety management server 101. For example, the client device 115 sends a query image to the safety management server 101 and the safety management server 101 provides data about one or more objects recognized in the query image to the client device 115.

The safety management application 103 may include software and/or logic to provide the functionality for analyzing images and identifying safe and unsafe working conditions. In some embodiments, the safety management application 103 can be implemented using a combination of hardware and software. In other embodiments, the safety management application 103 may be stored and executed on a combination of the client devices 115 and the safety management server 101, or by any one of the client devices 115 or safety management server 101.

In some embodiments, the safety management application 103b acts as a thin-client application with some functionality executed on the client device 115 and additional functionality executed on the safety management server 101 by safety management application 103a. For example, the safety management application 103b on the client device 115 could include software and/or logic for capturing the image, transmitting the image to the safety management server 101, and displaying image recognition results. A thin-client application 103b may include further functionality described herein with reference to safety management application 103, such as, processing the image and performing feature identification. The operation of the safety management application 103 and the functions listed above are described in more detail below.

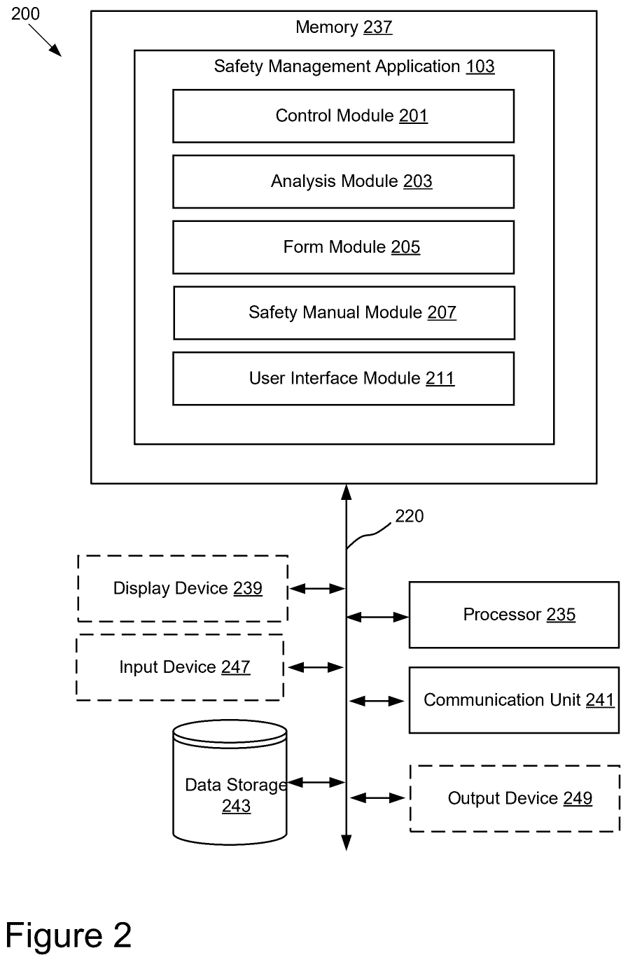

FIG. 2 shows a block diagram illustrating one embodiment of a computing device 200 including a safety management application 103. The computing device 200 may also include a processor 235, a memory 237, a communication unit 241, data storage 243, display device 239, a input device 247, and output device 249 according to some examples. The components of the computing device 200 are communicatively coupled by a bus 220. In some embodiments, the computing device 200 may be the client device 115, the safety management server 101, or a combination of the client device 115 and the safety management server 101. In such embodiments where the computing device 200 is the client device 115 or the safety management server 101, it should be understood that the client device 115, and the safety management server 101 may include other components not shown in FIG. 2.

The processor 235 may execute software instructions by performing various input/output, logical, and/or mathematical operations. The processor 235 may be physical and/or virtual, and may include a single processing unit or a plurality of processing units and/or cores. In some implementations, the processor 235 may be capable of generating and providing electronic display signals to a display device, supporting the display of images, capturing and transmitting images, performing complex tasks including various types of feature extraction and sampling, etc. In some implementations, the processor 235 may be coupled to the memory 237 via the bus 220 to access data and instructions therefrom and store data therein. The bus 220 may couple the processor 235 to the other components of the computing device 200 including, for example, the communication unit 241, and the data storage 243. It will be apparent to one skilled in the art that other processors, operating systems, sensors, displays and physical configurations are possible.

The memory 237 may store and provide access to data for the other components of the computing device 200. The memory 237 may be included in a single computing device or distributed among a plurality of computing devices as discussed elsewhere herein. In some implementations, the memory 237 may store instructions and/or data that may be executed by the processor 235. The instructions and/or data may include code for performing the techniques described herein. For example, in one embodiment, the memory 237 may store the safety management application 103. The memory 237 is also capable of storing other instructions and data, including, for example, an operating system, hardware drivers, other software applications, databases, etc. The memory 237 may be coupled to the bus 220 for communication with the processor 235 and the other components of the computing device 200.

The memory 237 may include one or more non-transitory computer-usable (e.g., readable, writeable) device, dynamic random access memory (DRAM) device, a static random access memory (SRAM) device, an embedded memory device, a discrete memory device (e.g., a PROM, FPROM, ROM), a hard disk drive, an optical disk drive, or other mediums, which can be any tangible apparatus or device that can contain, store, communicate, or transport instructions, data, computer programs, software, code, routines, etc., for processing by or in connection with the processor 235. It should be understood that the memory 237 may be a single device or may include multiple types of devices and configurations.

The communication unit 241 is hardware for receiving and transmitting data by linking the processor 235 to the network 105 and other processing systems. The communication unit 241 receives data such as requests from the client device 115 and transmits the requests to the control module 201, for example a request to process an image. The communication unit 241 also transmits information including recognition results to the client device 115 for display, for example, in response to processing the image. The communication unit 241 is coupled to the bus 220. In one embodiment, the communication unit 241 may include a port for direct physical connection to the client device 115 or to another communication channel. For example, the communication unit 241 may include an RJ45 port or similar port for wired communication with the client device 115. In another embodiment, the communication unit 241 may include a wireless transceiver (not shown) for exchanging data with the client device 115 or any other communication channel using one or more wireless communication methods, such as IEEE 802.11, IEEE 802.16, Bluetooth® or another suitable wireless communication method.

In yet another embodiment, the communication unit 241 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another embodiment, the communication unit 241 may include a wired port and a wireless transceiver. The communication unit 241 also provides other conventional connections to the network 105 for distribution of files and/or media objects using standard network protocols such as TCP/IP, HTTP, HTTPS and SMTP as will be understood to those skilled in the art.

The data storage 243 is a non-transitory memory that stores data for providing the functionality described herein. The data storage 243 may be a non-volatile memory or similar permanent storage device and media including a hard disk drive, a flash memory device, or some other mass storage device for storing information on a more permanent basis. In the illustrated embodiment, the data storage 243 is communicatively coupled to the bus 220. The data storage 243 may store data for analyzing a received image and results of the analysis and other functionality as described herein. For example, the data storage 243 may store a captured image and the set of features determined for the captured image. The data stored in the data storage 243 is described below in more detail.

In the illustrated embodiment, the display device 239 may be a screen for displaying a preview image or a user interface. The display device 239 may be incorporated into client device 115 or other device capable of being configured with a display screen.

In the illustrated embodiments, the input device 247 may be a device capable of capturing and/or receiving multimodal data, including audio, video, images, text messages, other mobile device sensor data (e.g., temperature, location, altitude, barometer, etc.) related to a workplace environment. In one embodiment, input device 247 may be any device capable of capturing an image, including a camera, or similar device. In another embodiment, input device 247 may be a microphone capable of capturing a worker's voice input or environmental sounds. In another embodiment, input device 247 may be a touchscreen or other tactile input device. The input device 247 may be a stand-alone device or configured to be part of a client device 115. The input device 247 may be configured to connect to the processor 235 and data storage 243 to receive and send information from the safety management application 103. While the foregoing embodiments are described for the input device 247, it should be understood that the input device 247 may comprise any suitable combination of input devices and/or other suitable input devices capable of providing the benefit described herein.

In the illustrated embodiment, the output device 249, may be any device capable of producing an output to a user. The output device 249 may be a speaker, an image presented on a user interface, a vibration on a client device 115 or another output that is capable of being detected by a user.

In some embodiments, the safety management application 103 may include a control module 201, an analysis module 203, and a user interface module 211. The control module 201 may include software and/or logic to control the operation of the other components of the safety management application 103. The control module 201 controls the other components of the safety management application 103 to perform the methods described below. The control module 201 may also include software and/or logic to provide the functionality for handling communications between the safety management application 103 and other components of the computing device 200 as well as between the components of the safety management application 103. In some implementations, the control module 201 is stored in the memory 237 and is accessible and executable by the processor 235.

In some embodiments, the control module 201 sends and receives data, via the communication unit 241, to and from one or more of the client device 115 and the safety management server 101. For example, the control module 201 receives, via the communication unit 241, multimodal data (e.g., an image) from a client device 115 operated by a user and sends the data to the analysis module 203. In another example, the control module 201 receives data for providing a graphical user interface to a user from the user interface module 211 and sends the data to a client device 115, causing the client device 115 to present the user interface to the user.

The analysis module 203 may include software and/or logic to provide the functionality for analyzing multimodal data and providing results to other components of safety management application 103. For example, analysis module 203 may receive images of a worksite and detect features of interest (e.g., unsafe working conditions, safe working conditions, etc.). In another example, analysis module 203 may receive an audio stream of a worker performing a pre task plan or checklist and analyze the audio to fill out a form, complete a checklist, etc. In some embodiments, the analysis module 203 is a set of instructions executable by the processor 235. In some implementations, the analysis module 203 is stored in the memory 237 and is accessible and executable by the processor 235.

In one embodiment, the analysis module 203 may be configured to identify safety conditions using a trained image recognition model. In some embodiments, images stored in data storage 243 are labeled and tagged to train the model. To create a robust model, data storage 243 may include a large number of tagged images that show safety hazards and/or safety standard violations as well as examples of safe working conditions. In some embodiments, the training images are captured in the environment where monitoring will take place (e.g., construction site, factory, etc.). As more images are captured and tagged, the additional images can be fed through the model as additional training. The model may be used to generate typical conditions (i.e., safety issues or safe working conditions) in a given work environment or associated with a specific task. These typical conditions can be used as training materials for workers and point to conditions for which the workers should be looking for to work safely. Additionally, the model may provide suggestions for the workers on how to remediate typical unsafe working conditions.

In some embodiments, the safety management application 103 can be used as a training tool to help users identify safe and unsafe working conditions. For example, when a user submits a safety observation via the safety management application 103, in addition to providing a mechanism to follow through on corrective actions for the observed safety issue as discussed below, the safety management application 103 can analyze the image and highlight other potential unsafe or safe working conditions and highlight them for the user. Highlighting safe working conditions and providing positive feedback can be a valuable mechanism for creating and maintaining a safe work environment. In some embodiments, the safety observations may include links to other resources, e.g., a company handbook or safety manual, for more information directly related to the feedback being provided.

The user interface module 211 may include software and/or logic for providing user interfaces to a user. In some implementations, the user interface module 211 is stored in memory 237 and is accessible and executable by processor 235. In some embodiments, user interface module 211 receives instructions from analysis module 203 or other modules of safety management application 103 to generate a graphical user interface to display results of an image analysis, track follow up obligations, and/or escalate a safety issue. In other embodiments, the user interface module 211 sends graphical user interface data to an application (e.g., a native or browser application) in the client device 115 via the communication unit 241 causing the application to display the data as a graphical user interface.

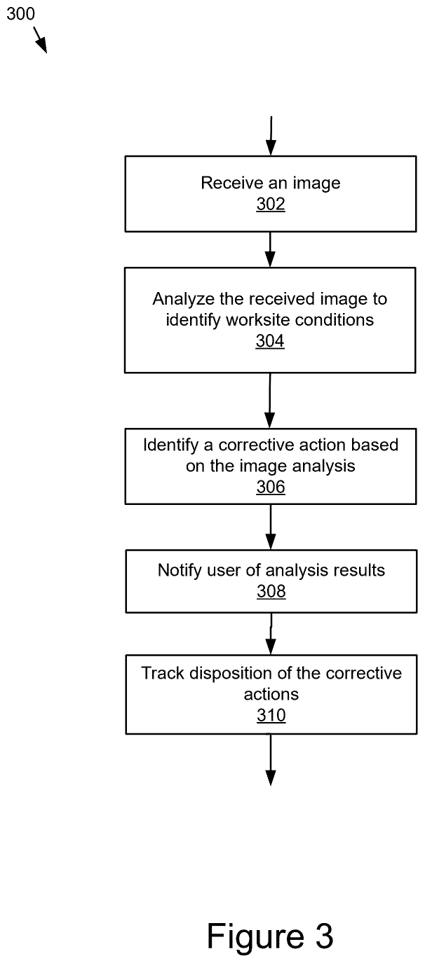

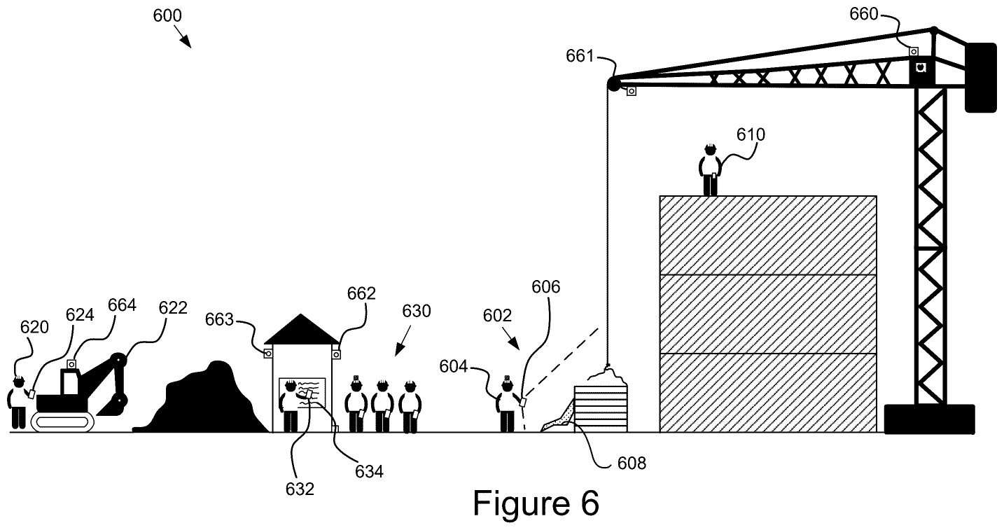

FIG. 3 is a flowchart depicting an example method 300 for analyzing an image and providing notifications and feedback, according to the techniques introduced herein. At 302, safety management application 103 receives an image. In one embodiment, a worker or safety inspector captures an image using client device 115 and submits the image via user interface module 211. For example, referring to the workplace environment 600 depicted in FIG. 6, incident 602 may be captured by worker 604 using a capture device, such as a camera of mobile device 606, to document fallen debris 608. In some embodiments, the image submission may include an identification of safe and/or unsafe conditions identified by a user, e.g., worker 604, via user interface module 211. In other embodiments, a site camera, such as camera 660, 661, 662, 663, or 664, or drone can provide an image or video stream (live or recorded) to safety management application 103.

At 304, analysis module 203, analyzes the received image to identify worksite conditions. The analysis module 203 analyzes the image using the trained model as described above. As part of the analysis, the analysis module 203 identifies working conditions that the model has identified as safe and/or unsafe. For example, the analysis module 203 may identify an unsafe working condition, such as snow and/or ice that may be mitigated prior to a majority of the workforce arriving at the worksite, accumulated debris (e.g., fallen debris 608) that may cause a tripping hazard, user fatigue or stress, other user health conditions such as dehydration, or any other of a number of hazards, including holes that workers can fall in, puddles that are slipping hazards, a worker working at heights who is not tied off (e.g., worker 610), scaffolding that is not properly constructed, trenches that are not safely constructed, etc. While a user may identify one or more safety conditions in a submitted image, the analysis module 203 may identify additional safe and/or unsafe working conditions to provide as feedback to the user and other workers, as described in more detail below.

At 306, the analysis module 203 identifies a corrective action based on the image analysis. The model may include corrective actions associated with each of the identified unsafe working conditions such that, when an unsafe working conditions is identified, the analysis module 203 can return a corrective action with the identification of the unsafe working conditions. For example, the analysis module 203 may return a corrective action to clean up or cordon off fallen debris 608.

At 308, the analysis module 203 notifies the user of the analysis results. In some embodiments, the analysis module 203 notifies the user via the user interface module 211. In one embodiment, the user interface module 211 may display an interface for the safety management application 103 on client device 115. The analysis module 203 may provide a notification to the user via the interface. For example, worker 604 may be notified via a user interface on mobile device 606. Alternatively, or in addition, the analysis module may provide the notification to the user via email, SMS message, or the like. The notification may include a list of safety issues identified in the image and one or more corrective actions for the user to take in order to improve or eliminate the safety issue.

At 310, the analysis module tracks disposition of the corrective actions. In some embodiments, the interface of the safety management application 103 may include options for the user to mark whether a corrective action has been taken for each safety issue for which a notification was received. If the user does not mark the corrective action as complete, the analysis module 203 may send follow-up notifications to encourage the user to follow through with the correction actions. In some embodiments, if a certain period of time elapses without the corrective actions being marked as complete, the analysis module 203 can escalate the safety issue and the corrective actions to a supervisory user to ensure that corrective actions are taken and the workplace remains safe.

Returning to the example of FIG. 2, in some embodiments, safety management application 103 may include form module 205. Form module 205 may be configured to ingest natural speech from a worker (e.g., a safety observer) and assist in completing safety documentation. One barrier to having good safety documentation is the time that it takes for a worker to find and complete the appropriate safety documentation for an incident, observation, and/or safety audit. Another barrier in high risk industries, where personal protective equipment (PPE) (e.g., gloves, hard hat, etc.) is worn, is having to remove PPE to interact with software for an observation when it would be a safety violation in itself to remove the PPE. Form module 205 of safety management application 103 can include a natural language model configured to use natural language and other contextual information (e.g., the speaker's location and identity, time, date, etc.) to make completing safety documentation more attainable. Advantages of using a natural language model to assist in completing safety documentation include not having to find the correct form, not requiring a worker to remove PPE, can be completed in various languages, etc.

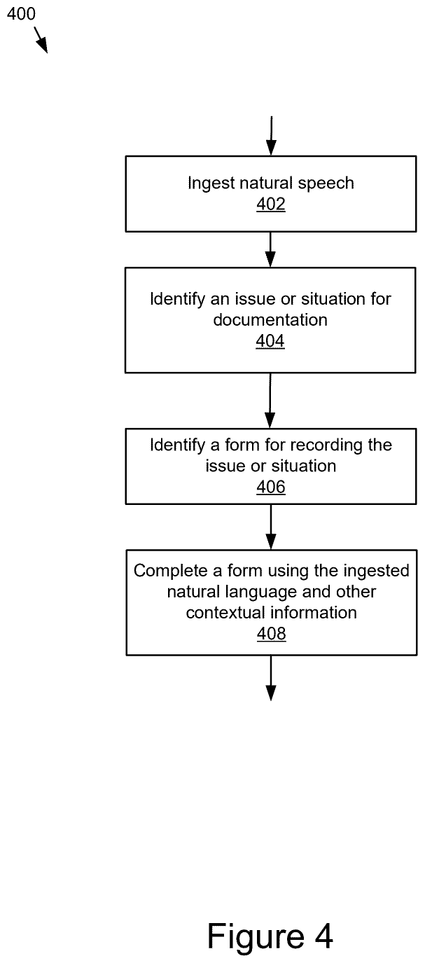

FIG. 4 is a flowchart depicting an example method 400 for completing safety documentation, according to the techniques introduced herein. At 402, form module 205 ingests natural speech. In some embodiments, control module 201 initiates form module 205 upon identifying a trigger from a user of client device 115. For example, a user may trigger a safety observation using a voice command to a virtual assistant on the client device 115 (e.g., “Hey Siri”, “Ok Google”, or the like), the user may select an option from a user interface to complete a form, or the user may scan a QR code, interact with an object via RFID, etc. In any event, based on the trigger, form module 205 begins ingesting natural speech from a user, or the user's environment. For example, after initiating the process a user can audibly make a safety observation by saying “AAA Framing is working at heights and is not tied off.” In another example, referring again to the workplace environment 600 depicted in the example of FIG. 6, form module 205 may be configured to assist worker 620 in completing an inspection checklist on excavator 622.

At 404, form module 205 uses its natural language model to identify an issue or a situation for documentation. In the example given above, the natural language model can identify that there is a safety issue (e.g., a fall protection issue) with a particular contractor or worker's (e.g., AAA Framing). In another example, form module 205 determines that worker 620 wants to complete an inspection of excavator 622. Some issues or situations that the natural language model of form module 205 may identify include are, for example, worksite observations, completing a pre-task plan (e.g., job safety analysis (JSA), job hazard analysis (JHA), Take 5, etc.), completing a worksite audit, performing a worksite safety walk, completing a safety inspection form, filling out a quality inspection form, tracking a safety meeting, etc.

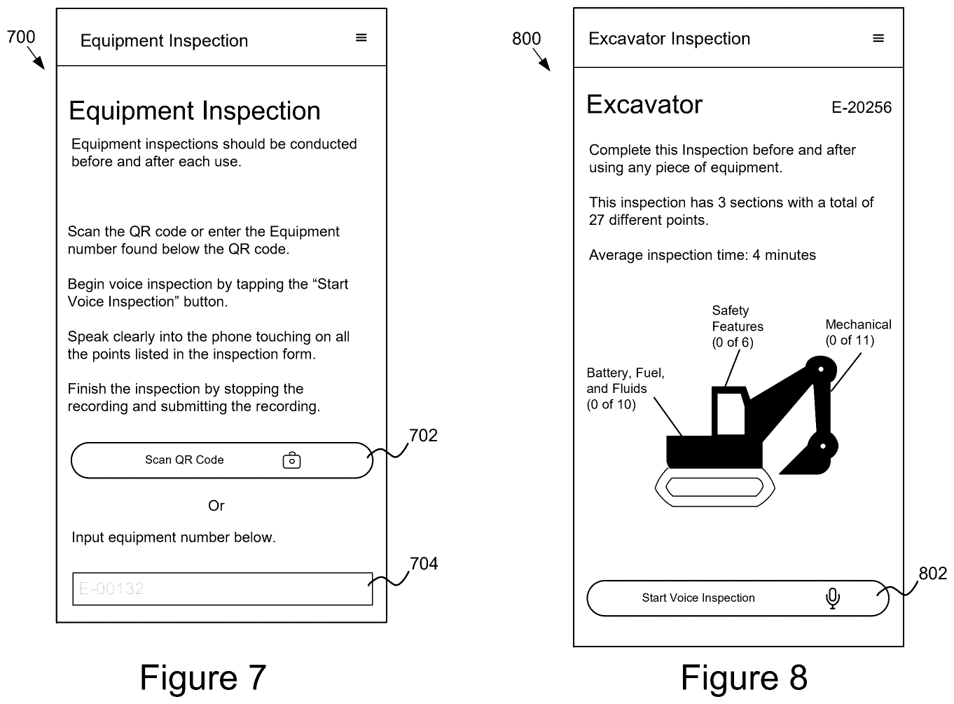

At 406, form module 205 uses its natural language model to identify the appropriate form to complete based on the identified issue or situation. Continuing with the example above, form module 205 identifies that a safety observation form is to be completed based on the language that a worker is working at heights without adequate safety protections. In another example, form module 205 identifies and opens the appropriate form for worker 620 to perform an equipment inspection on excavator 622 using a safety application on mobile device 624. In some embodiments, the form may be a conversational checklist as described below. FIGS. 7-10 depict example graphical user interfaces for completing a conversational checklist.

FIG. 7 depicts an example of a first user interface 700 for a conversational checklist. The first user interface 700 provides instructions for a user (e.g., worker 620) to complete the conversational checklist. For example, first user interface 700 may include a first element 702 which, when clicked by the user, allows the user to scan a QR code to identify the piece of equipment to be inspected. It should be noted that other forms of equipment identification (e.g., near field communication, etc.) may be used to identify the equipment. Alternatively, first user interface 700 provides an input field 704 where a user can input an equipment control number to begin the conversational checklist for a specific piece of equipment. Input field 704 may be completed by the user typing or speaking the equipment number.

At 408, form module 205 completes a form using the ingested natural language and other contextual information identified by form module 205. Form module 205 may use the natural language model (e.g., a large language model and/or other proprietary models) to convert the natural language and contextual information (e.g., location, time, date, etc.) into structured data elements to complete the form. Continuing with the safety issue example above, form module 205 may identify the speaker, use a location from client device 115 to identify a worksite location, and use the time and date from client device 115 to complete a safety observation form that includes the name of the observer, the worksite, the observations being made and the safety issue identified all without the user having to find the appropriate form and manually complete the required fields. This method can save the observer time and ensure that appropriate documentation of the situation is made.

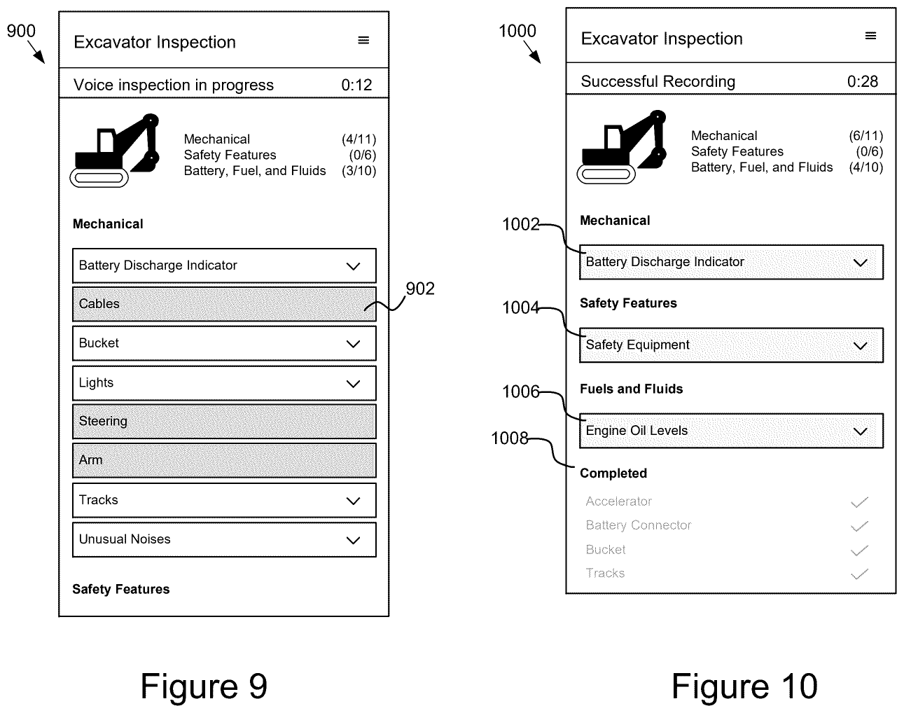

In the conversational checklist example, form module 205 may iterate through and complete an inspection checklist as a user performs the checks and audibly recounts the steps. FIG. 8 depicts an example of a second user interface 800 for a conversational checklist. In the example of worker 620 performing an inspection on excavator 622, the user may initiate the conversational checklist by clicking on element 802. Form module 205, in response to the user initiating the conversational checklist, begins ingesting the user's dialogue of the inspection. FIG. 9 depicts an example of a third user interface 900 for a conversational checklist. As the user is performing the inspection, the user may dictate the steps taken. For example, upon inspection of the battery cables, the user may say “battery cables are connected and free from damage.” In response, form module 205 passes the audio to analysis module 203 and analysis module 203 identifies a field of the form to complete and provides instructions to form module 205 to mark the battery cable element 902 complete. The process continues as the user works through the checklist and describes the checks and results. In one embodiment, as items are completed by form module 205, the items are removed from the checklist so that the user has a shorter list of remaining items to complete.

FIG. 10 depicts an example of a fourth user interface 1000 for a conversational checklist. In the event that a user does not fully complete a conversational checklist, form module 205 may provide the status of the checklist to the user. In the example of FIG. 10, form module 205 provides an interface that shows the section 1002, 1004, and 1006 of the checklist are incomplete and also may provide a list 1008 of completed checklist items. The user can then pick back up on the checklist and complete the needed tasks. In some embodiments, if the user does not complete the checklist, form module 205 may initiate follow up to the user. For example, form module 205 may initiate a text message to the user stating that the checklist is incomplete and providing a link to complete or ask for further instructions from the user.

In addition to recording information on forms, form module 205 may additionally provide guidance based on the ingested natural language. For example, form module 205 may suggest remedial actions to be taken to reduce hazards based on the observation being made. Additionally, form module 205 may identify other potential hazards of a given task based on the observation or suggest specific controls to have in place for the given task.

In one embodiment, form module 205 may provide a score and feedback. For example, if a safety meeting, such as a pre task planning meeting (PTP), JSA, JHA, or other safety meeting, is being conducted, form module 205 may analyze the meeting and provide a score and feedback for improving the safety meeting. The meeting score may be based on what takes place during the meeting including, for example, how many questions were asked during the meeting, how engaged were the participants in the meeting (i.e., how many different participants contributed to the conversation), the tone of the speakers, etc. In addition, the form module 205 may use information ingested from the meeting to complete a pre-task safety plan, JSA, JHA, etc.

Returning to the example of FIG. 2, in some embodiments, safety management application 103 may include safety manual module 207. In one embodiment, safety manual module 207 may instantiate a chatbot or other virtual assistant trained with knowledge on company safety procedures, a worksite safety manual, standard operating procedures, specific project safety requirements, or any other documentation that can answer workforce questions related to safety, work quality, or the like. Workers can access the functionality provided by the safety manual module 207 via a voice command, QR code, an application presented by user interface module 211, etc. Advantages of having a chatbot or virtual assistant available for safety queries include, for example, safety information can be maintained in a central location and kept up to date with the latest company and industry best practices and policies. Additionally, the safety information provided by the chatbot or virtual assistant can be universally accessed without a worker having to search for a paper manual that may or may not be up to date. Further, using capable multimodal LLMs, the chatbot may interact with workers in various languages, providing wider access to safety materials and providing a safer working environment.

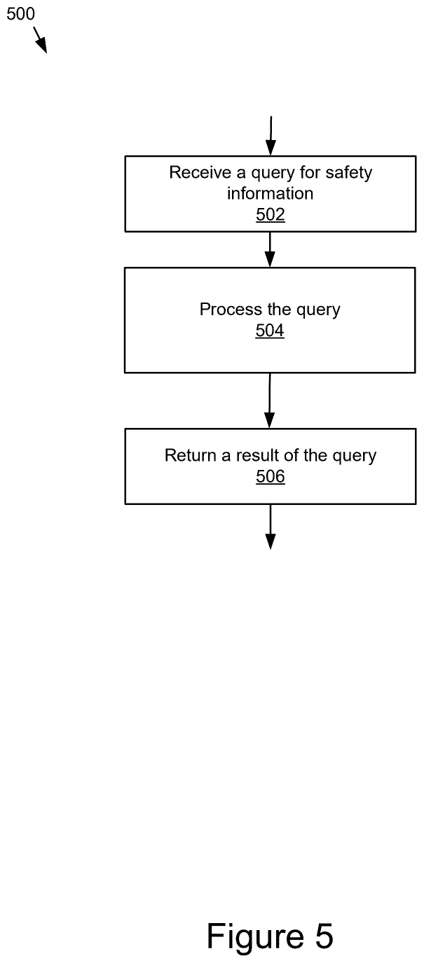

FIG. 5 is a flowchart depicting an example method 500 for accessing safety information using a trained chatbot, according to the techniques introduced herein. At 502, safety manual module 207 receives a query for safety information. The query may be made by a user via a voice query, via a search bar function in a user interface, or the like. At 504, safety manual module 207 processes the query. For example, safety manual module 207 may process the voice query using natural language processing techniques. At 506, safety manual module 207 returns a result of the query. The result may be presented to the user in various ways. For example, safety manual module may produce an audible answer to the query, a written answer to the query, and/or provide links to specific sections of the safety manual or other documentation where the result was found.

As can be seen from the example embodiments described above, safety management application 103 can provide a holistic solution to workplace safety and provide assistance to workplace personnel along the way. For example, safety management application 103 may provide a construction foreman with a summary of past safety observations prior to a morning safety meeting (e.g., meeting 630) so the foreman can be prepared to brief the construction crew with ongoing safety issues. During the safety briefing, form module 205 may ingest information regarding the meeting. For example, dialogue from the meeting may be captured by the foreman's mobile device 632, images and video, including audio, may be captured by the foreman's mobile device 632, or another camera in workplace environment 600, for example camera 662 or 663, the foreman may also take and submit images of a whiteboard 634, or the like, containing notes and/or action items for the meeting. Form module 205 may use the ingested information to fill out necessary forms for the day including, for example, a pre-task plan, JSA, JHA, or the like. Additionally, safety manual module 207 and/or form module 205 may provide the foreman with recommendations to improve the pre-task plan and/or recommendations on additional observations to make throughout the day in order to improve workplace safety. The safety manual module 207 may further provide the workforce with safety tips throughout the workday via SMS, push notifications, email, etc. based on pre-task planning and past safety observations.

The foregoing description, for purpose of explanation, has been described with reference to various embodiments and examples. However, the illustrative discussions above are not intended to be exhaustive or to limit the invention to the precise forms disclosed. Many modifications and variations are possible in view of the above teachings. The various embodiments and examples were chosen and described in order to best explain the principles of the invention and its practical applications, to thereby enable others skilled in the art to utilize the innovative technology with various modifications as may be suited to the particular use contemplated. For instance, it should be understood that the technology described herein can be practiced without these specific details in some cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method for providing feedback in a workplace environment via a mobile device, the method comprising:
training a model to identify safety hazards and corrective actions based on a plurality of tagged images;
receiving an image from the mobile device, the image including a workplace scene;
recognizing a safety hazard in the workplace scene using the model;
identifying a corrective action to remediate the safety hazard; and
providing, via a user interface of the mobile device, the corrective action to a user.

2. The method of claim 1, further comprising:
providing, via the user interface of the mobile device, an additional resource relating to the safety hazard to the user.

3. The method of claim 2, wherein the additional resource includes a link to a safety manual with safe workplace policies related to the workplace scene.

4. The method of claim 1, further comprising:
recognizing a safe working condition in the workplace scene using the model; and
providing feedback to the user reinforcing the safe working condition.

5. The method of claim 1, further comprising:
escalating the corrective action in response to determining that no corrective action has been taken to remediate the safety hazard.

6. A method for completing a form using multimodal input, the method comprising:
ingesting a first input;
identifying a situation for documentation based on the first input;
identifying a form for recording the situation; and
completing the form using the ingested first input and other contextual information.

7. The method of claim 6, wherein the contextual information includes an identity of a speaker, a date, a time, and a location.

8. The method of claim 6, wherein the situation comprises a safety observation or a safety meeting.

9. The method of claim 8, wherein the first input comprises natural speech ingested from a safety meeting and further comprising:
generating a score for the safety meeting based on the natural speech ingested from the safety meeting.

10. The method of claim 8, wherein the first input comprises natural speech and the situation for documentation comprises completing an equipment inspection checklist.

11. The method of claim 10, wherein the natural speech includes a verbal description of observations from a person completing the equipment inspection checklist.

12. The method of claim 11, further comprising:
analyzing the verbal description of observations from the person completing the equipment inspection checklist to determine that a task on the equipment inspection checklist has been completed; and
automatically marking the task on the equipment checklist as completed based on a determination that the task from the equipment inspection has been completed.

13. The method of claim 6, wherein the first input comprises a text message and the method further comprising:
sending a response to the text message identifying the form and requesting additional information required to complete the form.

14. A method for completing a checklist using conversational input on a mobile device, the method comprising:
capturing a checklist identifier using the mobile device;
displaying the checklist on a display of the mobile device;
receiving an input to begin completing the checklist;
detecting a conversational input from a user of the mobile device;
analyzing the conversational input to identify completion of a checklist item; and
automatically marking the checklist item as completed in response to identifying the completion of the checklist item.

15. The method of claim 14, wherein analyzing the conversational input further comprises:
providing the conversational input to a LLM model;
receiving from the LLM model, an identification of the checklist item that has been completed based on the conversational input.

16. The method of claim 14, further comprising:
hiding the checklist item from a list of checklist items on the display of the mobile device in response to automatically marking the checklist item as completed.
